(19) United States
(12) Patent Application Publication
(10) Pub. No.: US 2017/0165626 A1
(43) Pub. Date: Jun. 15, 2017

(54) Element for Injecting Fuel into a Regenerator of a Fluid Catalytic Cracking Unit

(71) Applicant: Total Raffinage Chimie, Courbevoie (FR)

(72) Inventors: Marc Bories, Saint-Nazaire (FR); Michaël Echard, Montivilliers (FR); Romain Lesage, Montivilliers (FR); Lassad Rezgui, Bondy (FR); Jean-Christophe Raboin, Chaumont sur Tharonne (FR)

(21) Appl. No.: 15/327,289

(22) PCT Filed: Jul. 23, 2015
(86) PCT No.: PCT/EP2015/066908

§ 371 Date: Jan. 18, 2017

(30) Foreign Application Priority Data
Jul. 28, 2014 (FR) 1457255

(51) Int. Cl. B01J 8/18; C10G 11/18

(52) U.S. Cl. CPC B01J 8/1827; C10G 11/182; B01J 2208/00902

(57) ABSTRACT

An injection element (10) for a system for injecting fuel into a regenerator of a fluid catalytic cracking unit, said injection element defining a flow passage (12) and being arranged so as to be able to be fastened to an orifice passing through the regenerator so that one end of the flow passage (12) is connected to a duct for supplying the injection system with fuel and the other end of the flow passage opens inside the regenerator,
characterized in that
said injection element is made of ceramic material.

The invention relates to the injection of fuel into a regenerator of a fluid catalytic cracking (FCC) unit.

Fluid catalytic cracking is an oil refining process that consists in reducing the size of hydrocarbon molecules by action of temperature in the presence of a solid catalyst. This catalyst is held in a fluidized state and circulates continuously inside the cracking unit by passing from a reaction zone to a regeneration zone.

In the reaction zone, the feedstock to be treated and the catalyst are introduced together into a substantially vertical tubular reactor, which may have ascending flow, customarily known as a riser reactor, or have descending flow, customarily known as a downer reactor. The temperature of the reactor may achieve several hundreds of degrees centigrade, for example from 520° C. to 550° C.

In the regeneration zone, a regenerator comprises a chamber in which the coke deposited on the catalyst by the cracking of the feedstock is burnt. This combustion of the coke makes it possible to restore the catalyst's activity and provides it with the energy needed for heating, vaporizing and cracking the feedstock supplied in the tubular reactor.

The combustion reaction of the coke requires a supply of oxygen. This is mainly provided by air. The combustion carried out inside the regenerator may be complete or partial depending on whether all of the coke is burnt or not. This reaction produces carbon dioxide. The catalyst that is regenerated is supplied to the inlet of the tubular reactor.

The temperature in the regenerator is of the order of 600° C. to 700° C.

A system for injecting fuel, also referred to as “torch oil”, may make it possible to provide additional energy for facilitating the regeneration reaction. The fuel thus injected may for example be gas oil, or other fuel.

The fuel injection system may comprise one or more ducts supplying injection nozzles with fuel. The presence of several nozzles may make it possible to inject the fuel relatively uniformly into the regenerator.

Each injection nozzle, also referred to as a “pipe”, is in general inserted inside a sleeve that passes through the wall of a regenerator chamber of a fluid catalytic cracking unit, this sleeve being itself fastened to the wall. One end of the nozzle opens inside the chamber, the other end being connected to a fuel supply duct, optionally via a flow control device, of valve type.

These nozzles, made from special steels, having an improved abrasion resistance, must nevertheless be regularly replaced owing to relatively high abrasion. Indeed, the erosion of the steel is capable of leading to a deterioration of the performances and an abrasion of the fuel injection qualities.

There is therefore a need for a system for which the maintenance could be less restrictive.

An injection element is proposed for a system for injecting fuel into a regenerator of a fluid catalytic cracking unit, this injection element defining a flow passage and being arranged so as to be able to be firmly attached to an orifice passing through the regenerator so that one end of the flow passage is connected to a duct for supplying the injection system with fuel and the other end of this flow passage opens inside the regenerator, characterized in that this injection element is made of ceramic material.

Such an injection element, for example an injection nozzle, may have a relatively high resistance to the abrasion caused by the stream of catalyst passing in contact with the surface via a vortex effect, so that this injection element may be replaced less often than in the prior art.

In addition, the design constraints, in particular the constraints linked to the erosion induced by the catalyst particles, may be less important than in the prior art. It is thus possible to design fuel injection elements with an optimized shape in order to enable a better distribution of the fuel within the regenerator, which may thus make it possible to maintain the quality of the catalyst. In particular, the number and intensity of the hot spots within the regenerator will be able to be reduced with respect to the prior art.

In addition, the weight of this injection element may be lower than the weight of a steel injection element of the type known from the prior art.

Thus, one feature of the invention lies in the fact that the injection element is manufactured mainly, and advantageously entirely, from a ceramic material. The injection element is thus made of ceramic, at least as regards its main elements, for example a hollow cylindrical body defining the flow passage for the fuel.

Ceramic materials have a relatively high hardness, namely a hardness of at least 1400 N/mm² as Vickers hardness. Preferably, the ceramic material has a hardness of greater than 2100 N/mm² or even greater than 2500 N/mm².

Ceramic materials have proved suitable for the usage conditions of an FCC unit. In particular, these materials may have good corrosion resistance and thermal resistance.

Preferably, the ceramic material may be selected from silicon carbide SiC, boron carbide B₄C, silicon nitride Si₃N₄, aluminium nitride AlN, boron nitride BN, alumina Al₂O₃, or mixtures thereof. Preferably, the ceramic material is silicon carbide SiC.

Preferably, the ceramic material is silicon carbide SiC or comprises silicon carbide SiC, preferably in a majority amount, for example in a content of 60% to 99.9% by weight. Silicon carbide has the advantage of possessing good mechanical and physical properties for a reasonable manufacturing cost.

As a variant, or optionally in combination, the ceramic material may comprise a ceramic matrix, for example selected from silicon carbide SiC, boron carbide B₄C, silicon nitride Si₃N₄, aluminium nitride AlN, boron nitride BN, alumina Al₂O₃, or mixtures thereof. Incorporated in this ceramic matrix are fibres, for example carbon fibres, ceramic fibres, a mixture of these fibres, or other fibres.

The ceramic material is then a composite material. Such a composite material may be advantageous for the injection elements subjected to stretching and shear stresses. In particular, the fibres may be positioned randomly (pseudo-isotropically) or anisotropically. When they are present, these fibres may represent from 0.1% to 10% by weight of the composite material.

The carbon fibres may be carbon fibres with graphite planes oriented along the fibre.

The ceramic fibres may be selected from crystalline alumina fibres, mullite (3Al₂O₃, 2SiO₂) fibres, crystalline or amorphous silicon carbide fibres, zirconia fibres, silica-alumina fibres, or mixtures thereof.

For example, the composite ceramic material comprises a silicon carbide SiC matrix comprising fibres of the aforementioned type. The fibres may for example be silicon carbide fibres.

Advantageously and non-limitingly, the devices according to the invention are preferably made of CMC materials (CMC=Ceramic Matrix Composite), here identified as CMC devices. In other words, the composite material here above mentioned may be a CMC.

A method of preparation of these CMC devices is preferably performed as follows:
1) Shaping a fibrous ceramic material eventually over a supporting material that could be removed without excessive effort, in order to obtain a fibrous shape that can be assimilated to the backbone of the final device to be obtained, eventually in the presence of a first resin,
2) Coating the shape obtained at step (1) with finely divided ceramic powder and at least a second resin, eventually in the presence of finely divided carbon powder, to obtain a coated shape,
3) Eventually repeat steps (1) and (2),
4) Heating the coated shape of step (2) or (3) under vacuum and/or under inert atmosphere in order to transform the resins of step (1), (2) and eventually (3) into a carbon-rich structure, essentially deprived of other elements to obtain a carbon-rich coated shape,
5) Introducing a gas within the carbon-rich coated shape of step (4) under conditions efficient to transform the carbon-rich structure into carbide containing carbon-rich structure,
6) Eventually removing the supporting material of step (1), when present,

wherein carbon fibers are present at least at step (1), (2) and/or (3) within the fibrous ceramic material, within the finely divided ceramic powder, within the finely divided carbon powder, and/or within the first and/or second resin.

Preferably, the mixture of finely divided ceramic powder comprises ceramic fibers with lengths comprised between 100 nm to 5 mm in an amount from 0.1 to 20 Wt % relative to the total amount of finely divided ceramic powder+finely divided carbon powder when present.

Preferably, the fibrous ceramic material is made of non-woven fabric, woven fabric or knit made with at least one of thread, yarn, string, filament, cord, string, bundle, cable, eventually sewed to maintain the desired shape. The fibrous ceramic material and the resins can be present in an amount up to 50 wt % relative to the total amount of components. In these conditions, if a CMC is manufactured with 50 Wt % fibrous ceramic material and resins, and ceramic powder comprising 20 Wt % ceramic fibers is added, the overall content in free fibers, i.e. not contained in the fibrous ceramic material, before any thermal treatment, is 10 Wt %. (Wt %=weight percent).

The fibrous ceramic material is preferably made with carbon and/or silicon carbide fibers.

The first, second and further resin are independently selected among resins able to produce a carbon residue and to bind the different constituents of the ceramic material before thermal treatment. Suitable resins include preferably poly-methacrylic acid, poly methyl methacrylate, poly ethyl methacrylate, polymethacrylonitrile, polycarbonates, polyesters, polyolefins such as polyethylene and polypropylene, polyurethanes, polyamides, polyvinyl butyral, polyoxyethylene, phenolic resins, furfuryl alcohol resins, usual polymer precursors of carbon fibers such as polyacrylonitrile, rayon, petroleum pitch. The resins and their quantities are adjusted to the desired porosity that is obtained after thermal treatment of step (4) and before step (5). Preferably, the total porosity after treatment of step (4) should be comprised between 15 vol % and 25 vol %, more preferably between 20 vol % and 22 vol %. (Vol %=volume percent). Without wishing to be bound by theory, it is assumed the resins, when undergoing thermal treatment of step (4) transform into a network of cavities containing residual carbon atoms surrounded with voids. It is assumed the gas of step (5) moves preferentially within this network thus allowing improved homogeneity in the final CMC material. For example, 78 Wt % SiC powder which contains 0.2 Wt % of silicon carbide fiber is mixed with 17 Wt % phenolic resin and 5 Wt % poly methyl methacrylate and this mixture is used to impregnate and cover a silicon carbide fabric (which accounts for 20 Wt % of the overall weight) that surrounds a shaping support, then heated under inert gas atmosphere until complete carbonization of the resins to obtain a final product having from 16 vol % to 18 vol % total porosity.

The gas may be selected among SiH₄, SiCl₄, ZrCl₄, TiCl₄, BCl₃, to form corresponding carbide.

Preferred gas is SiH₄ or SiCl₄.

Preferred conditions of step (5) are standard RCVI conditions (Reactive Chemical Vapor Infiltration), more preferably using pulsed pressure.

Preferably steps (4) and (5) are each independently performed at a temperature comprised between 1100 and 1800° C. and at an absolute pressure comprised between 0.1 and 1 bar.

Preferably, the finely divided ceramic powder comprises, or eventually consists of, particles selected from silicon carbide SiC, boron carbide B₄C, silicon nitride Si₃N₄, aluminium nitride AlN, boron nitride BN, alumina Al₂O₃, or mixtures thereof.

Preferably, the finely divided carbon powder is carbon black.

A suitable but non limiting particle size range for the finely divided ceramic powder, and eventually finely divided carbon powder, is about 10 micrometers or less.

Such a method of preparation allows improved homogeneity in the CMC material in that porosity gradient and clogging at the surface of the material is considerably reduced or totally alleviated, depending on the experimental conditions (low temperatures ca. 1100-1300° C. and reduced pressure ca. 0.1-0.5 bar abs. are preferred). Advantageously and non-limitingly, the ceramic material may be a sintered ceramic material. This may in particular facilitate the production of the injection element, whether it is made from a single part or from several parts.

With regard to the dimension of the injection elements, it is possible to produce the injection element made of solid ceramic as a single part without assembling or welding. In this case, the injection element may be formed for example by moulding or by extrusion, followed by a firing of the green injection element, under conventional operating conditions suitable for the type of ceramic produced. The firing step is optionally preceded by a drying step.

In one particular embodiment, the injection element may be made from a single part made of ceramic material, obtained by sintering. The sintering step may be preceded by a conventional shaping step, for example by compression, extrusion or injection.

Sintering is a process for manufacturing parts that consists in heating a powder without melting it. Under the effect of heat, the grains fuse together, which forms the cohesion of the part. Sintering is especially used for obtaining the densification of ceramic materials and has the following advantages:
it makes it possible to control the density of the substance; as a powder is used to start with and since this powder does not melt, it is possible to control the size of the powder grains (particle size) and the density of the material, depending on the degree of initial compacting of the powders;
it makes it possible to obtain materials having a controlled porosity, that are chemically inert (low chemical reactivity and good corrosion resistance) and thermally inert;
it makes it possible to control the dimensions of the parts produced: as there is no change of state, the variations in volume and in dimensions are not very large with respect to melting (absence of shrinkage phenomenon).

In another particular embodiment, the injection element may comprise several parts made of ceramic material, assembled together.

Advantageously and non-limitingly, the inner and/or outer walls of the injection element may be smooth, in other words they may have a low surface roughness. Such smooth walls make it possible to improve the flexural strength of the injection element. Therefore, it is possible not only to design injection elements with relatively small dimensions, but also to plan to increase the fuel flow rates. This may make it possible to increase the number of injections elements, and generally, to homogenize the injection of fuel in the regenerator.

Such a smooth wall may be obtained when the ceramic material is a sintered ceramic material.

Advantageously and non-limitingly, the injection element may be obtained from a relatively fine sintering powder, for example having a mean grain diameter of less than or equal to 500 nm, which may result in relatively smooth surfaces.

Alternatively or in addition, the injection element may be obtained by adding to the main material, for example SiC, an additive selected from boron B, silicon Si and carbon C, or mixtures thereof, for example in a proportion varying from 0.3% to 2% by weight. In the case of an SiC material obtained by powder sintering, such an addition of additive may make it possible to reduce the porosity and consequently the roughness.

Advantageously and non-limitingly, the additive may comprise a mixture of boron B, silicon Si and carbon C. It may thus form additional SiC, which blocks the pores and thus reduces the roughness.

Alternatively or in addition, a step of additional deposition of SiC by chemical vapour deposition (CVD) could for example be provided.

Generally, the invention is not limited by a manufacture of the injection element so as to obtain a relatively low porosity. It will, for example, be possible to produce SiC injection nozzles with a relatively high porosity, by making provision for the pores to be filled in following depositions of carbon in the regenerator.

The injection element may have dimensions of the order of ten or so centimetres, or other dimensions. For example, for an injection element of cylindrical general shape with a flange bearing against the regenerator, the external diameter of the flange may be 5 or 6 centimetres, whereas the internal diameter of the flow passage may be 1 or 2 centimetres.

The invention is not limited to one particular flow passage shape. For example, a cylindrical flow passage, but also a flow passage with a portion of smaller cross section, could be provided. In the latter case, this nozzle shape, with a Venturi effect, may tend to limit the entry of catalyst into the flow passage.

The catalyst may comprise alumina, or other catalyst, for example a fluidized bed cracking catalyst.

A fuel injection system is moreover proposed for injecting fuel into a regenerator of a fluid catalytic cracking unit, this system comprising at least one injection element as described above and at least one fuel supply duct. At least one, and preferably each, injection element is arranged so that one end of the fuel injection flow passage is connected to the duct. The injection system being positioned so that the other end of the flow passage opens into the regenerator.

The fuel circulating inside the duct(s), positioned outside of the regenerator, may thus be injected into the regenerator via these respective injection flow passages.

Advantageously and non-limitingly, for at least one, and preferably each injection element, the injection system additionally comprises a support sleeve inside which the injection element extends, this support sleeve being intended to be positioned through a wall of the regenerator, the injection element being arranged so as to be firmly attached to this support sleeve.

The injection element is thus surrounded by the support sleeve, from which it may jut out on the side inside the regenerator.

Assembling of the injection element(s) to the support sleeve could be carried out taking account of the constraints linked to the physical properties of the materials used, when they are different. Thus, a steel support sleeve which is intended to hold a ceramic injection element will have to be constructed and arranged so that the differential expansion between the metal and the ceramic does not lead to a fracture of the ceramic part.

The metal support sleeve is advantageously provided with a concrete coating on the portion in contact with the inside of the regenerator, within the regeneration zone.

Advantageously and non-limitingly, for at least one and preferably each injection element, the injection system comprises a device for fastening this injection element to the support sleeve, said device being capable of absorbing a difference in expansion between the material of the support sleeve, for example metal, and the ceramic material of this injection element.

For example, the fastening device may be formed by a layer of materials essentially comprising assembled ceramic fibres having a non-zero elastic modulus, this layer being positioned between a portion made of ceramic material and a metal portion and providing the cohesion of these portions.

Alternatively, the geometry and the dimensions of the fastening device may be adapted in order to compensate for the difference in thermal expansion between the metal and the ceramic material.

Advantageously and non-limitingly, for at least one and preferably each injection element, the fastening device associated with this injection element comprises one (or more) pressing element(s) capable of exerting a force on this injection element in order to press this injection element against the support sleeve.

Thus, the fastening withstands the differential expansion between the material of the support sleeve, for example a steel, and the material of the injection device. Indeed, the ceramic may have a coefficient of thermal expansion that is much lower than that of the steel.

The pressing element may for example comprise a spring means, or other means. It will be possible, for example, to provide one or more tabs that are firmly attached to (or form a single part with) the support sleeve, for example that are welded to the support sleeve. These tabs, on the one hand welded via one end to the support sleeve, while the other end rests on a surface of the injection element, make it possible to exert an elastic bearing force on the injection element, when this is installed inside the support sleeve, so as to keep this injection element pressed against the support sleeve. This other end may have a relatively flat surface in order to limit the zones of high mechanical stresses.

Advantageously and non-limitingly, the injection element may define a bearing portion, shaped to rest on at least one portion of the perimeter of an orifice of the support sleeve and advantageously over the entire perimeter of this orifice when the pressing element(s) exert(s) a force on this bearing portion.

The bearing portion may for example have a general flange shape. The bearing portion may define a bearing surface against which the pressing element exerts a force, and, on the side opposite the bearing surface, a contact surface intended to come into contact over the perimeter of the orifice of the support sleeve, for example forming the end of the support sleeve.

The invention is not limited by the shape of the pressing element(s) either. Advantageously, it will be possible to provide tabs, for example made of steel, advantageously made of abrasion-resistant steel. These tabs extend between two ends, one of the ends being fastened to the duct, and the other of the ends being intended to come to rest on a bearing surface of the injection element.

In one embodiment, it will be possible to provide, instead of a tab welded to the support sleeve, a pressing element comprising a screw passing through the bearing portion of the injection element and screwed into the support sleeve and a spring positioned between the head of the screw and the bearing portion in order to exert a pressing force against the bearing portion.

A process is also proposed for installing a fuel injection element for a regenerator of a catalytic cracking unit, this injection element being made of ceramic material and defining a flow passage for the fuel, the process comprising a step of positioning the fuel injection element at an orifice of a wall of the regenerator, so that one end of the flow passage of the injection element is connected to a fuel supply duct and the other end of this flow passage opens inside the regenerator.

During the positioning step, the injection element may be inserted inside a support sleeve that passes through said orifice of the wall of the regenerator, this sleeve being fastened to this wall.

The process may then advantageously additionally comprise a step of installing one or more pressing element(s) arranged to exert a force on a bearing surface of the injection element, so that the injection element is held pressed against the support sleeve.

A process is additionally proposed for manufacturing a fuel injection element for a regenerator of a catalytic cracking unit, so that this element defines a flow passage for the fuel, one end of which is intended to be connected to a fuel supply duct, and the other end of which is intended to open inside the regenerator, the process being characterized in that the injection element is made of ceramic material.

The process could advantageously comprise a sintering step.

The invention will be better understood with reference to the figures, which show exemplary embodiments of the invention.

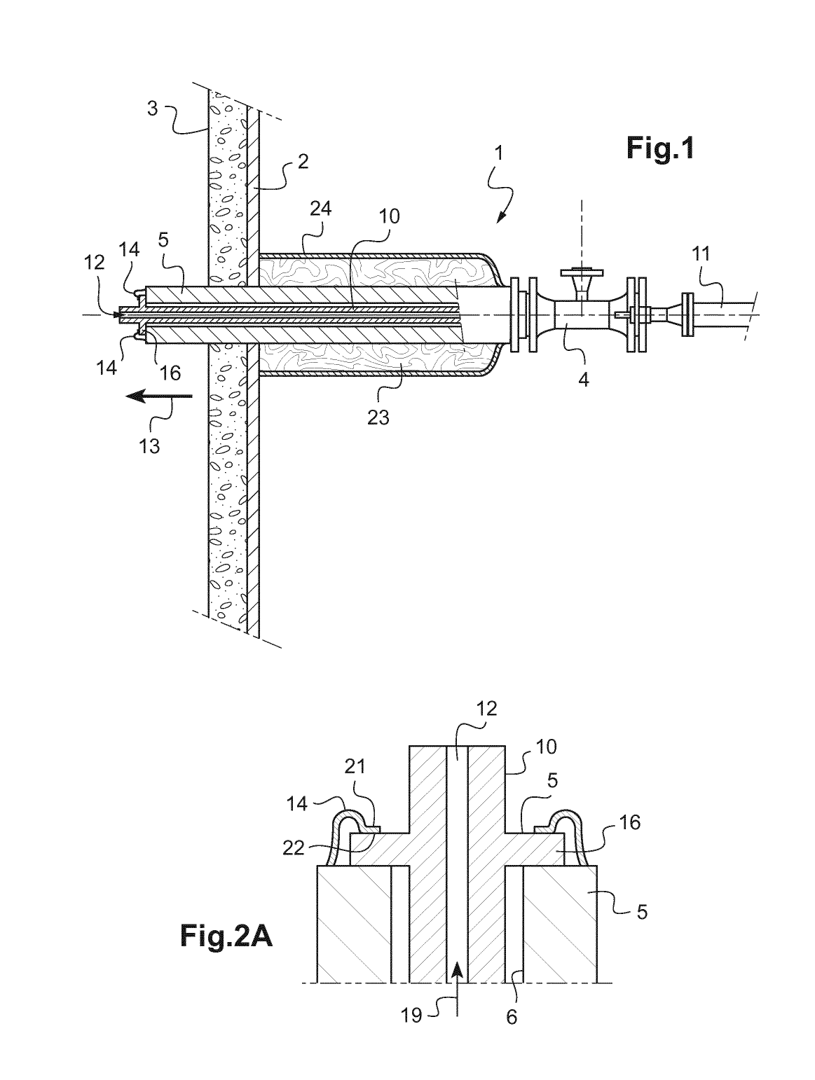

FIG. 1 shows an example of a fuel injection system according to one embodiment of the invention, shown on a regenerator wall.

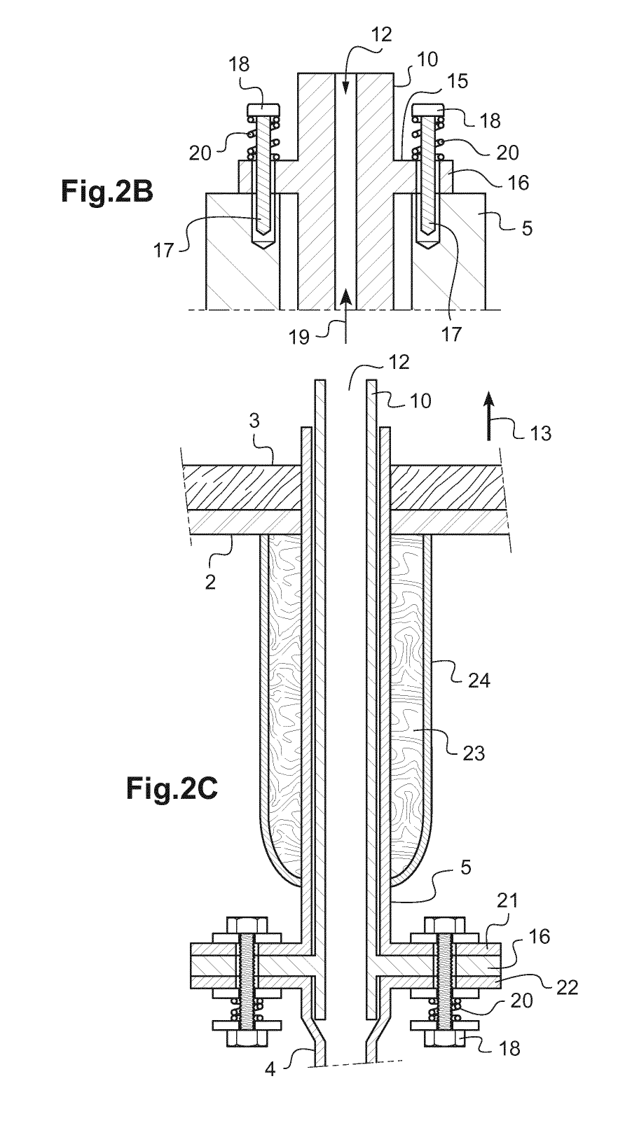

FIGS. 2A, 2B and 2C are cross-sectional views of three embodiments of a fuel injection element, when installed in a support sleeve.

Identical references may be used from one figure to the next to denote elements that are identical in their shape or in their function.

With reference to FIG. 1, the system 1 comprises a fuel injection element 10, for example an injection nozzle, shown on a wall 2 of a chamber, here a regenerator, and connected to a fuel supply duct 11.

The wall 2 is in general metallic and covered with an anti-erosion coating 3 of concrete type on the face thereof inside the regenerator.

The injection element 10 is connected to the fuel supply duct 11 by a flow control device 4. Here it is a three-way valve that makes it possible to connect the injection element to the fuel supply duct 11 or to a purge circuit supplied with air (not represented).

The system 1 also comprises a support sleeve 5, passing right through the wall 2. The support sleeve 5 supports the flow control device 4. It also receives the injection element 10, as represented.

The system 1 is intended to be installed in a regenerator of a fluid catalytic cracking (FCC) unit, of which only the wall 2 is represented, and serves to provide fuel, for example gas oil or heavy fuel oil, to the inside of this regenerator. The combustion of this fuel may make it possible to increase the temperature inside the regenerator, and thus to promote the combustion of coke deposited on catalyst resulting from a reactor of the FCC unit and to improve the thermal balance of the unit when there is not enough coke formed during the cracking reaction of a feedstock.

The injection nozzle 10 is made of ceramic, for example made of silicon carbide SiC.

This nozzle 10 is obtained by sintering a silicon carbide powder below its melting point.

Advantageously, ceramic fibres may be added during the preparation of the ceramic part, whether it is prepared by powder sintering or by a wet route, the wet route being that commonly used for making ceramic or porcelain crockery articles, or construction materials, for example clay bricks.

Preferably, from 0.1% to 10% by weight of ceramic fibres are added during the step of manufacturing the nozzle 10.

Such a nozzle, made of solid ceramic, has a relatively low manufacturing cost and does not result in a significant additional cost with respect to a steel that has undergone a surface treatment, for example a nitridation or a boration, or a special steel having an improved abrasion resistance.

The injection nozzle 10 defines a flow passage 12 in which fuel, for example heavy fuel oil or gas oil, is intended to circulate from the duct 11 to the inside of the regenerator, along the arrow 13.

The support sleeve 5 is made of steel having an improved abrasion resistance.

This support sleeve 5 defines an orifice 6, into which a large portion of the injection nozzle 10 is introduced. As seen in FIG. 1, the end of the nozzle 10 opening into the regenerator juts out from the support sleeve 5, which itself juts out from the wall 2 of the regenerator, inside the latter. For example, the support sleeve 5 may jut out by around 300 mm on the inside of the regenerator, the distance measured from the surface of the coating 3, and the nozzle 10 may jut out by 25 mm from the end of the support sleeve 5.

Pressing elements 14 (particular embodiments of which are described with reference to FIGS. 2A, 2B and 2C), here steel tabs welded to the support sleeve 5, at its end, make it possible to exert a pressing force on a bearing surface 15 of a flange 16 of the injection nozzle 10.

Thus, the other side of the flange 16 is pressed against the perimeter of the edge of the orifice 6.

If temperature variations lead to a variation in the dimensions of this orifice 6, the fastening of the injection nozzle 10 thus remains stable despite the possible expansion of the support sleeve 5 when the temperature varies.

In FIGS. 2A, 2B and 2C the same elements are denoted by the same numerical references.

FIG. 2A is a cross-sectional view of an example of a nozzle 10 according to a first embodiment of the invention.

This nozzle 10 defines a duct 12 for the flow passage of the fuel along the arrow 19, this fuel is intended to be ignited in the regenerator in order to increase the temperature inside the generator and thus promote the regeneration of the catalyst.

This nozzle 10 is made of silicon carbide and comprises a flange 16 that comes to rest on the edges of an orifice 6 of the support sleeve 5.

The nozzle 10 has a cylindrical general shape, as does the support sleeve 5 in this embodiment.

The diameter of the nozzle 10 is smaller than the diameter of the orifice 6, so that the expansion of the support sleeve 5 does not lead to a fracture of the injection nozzle 10.

Two tabs 14 are welded to the support sleeve 5, each tab 14 comprising an end 21 intended to exert an elastic bearing force on the flange 16.

Each end 21 comprises a flat side 22 in order to avoid regions of excessively high stresses on the flange 16 of the nozzle 10.

In the embodiment from FIG. 2B, the pressing elements comprise screws 17 passing through the flange 16 and screwed into the support sleeve 5. Each screw 17 has a head 18 against which the end of a helical spring 20 surrounding the shaft of the screw bears, the other end of this spring 20 bearing against the flange 16. The springs 20 thus make it possible to press the flange 16 against the support sleeve 5.

In the embodiment from FIG. 2C, the flange 16 on the nozzle 10 is clamped between a plate 21 formed in the extension of the support sleeve 5 and a plate 22 formed in the extension of the flow control device 4. The sleeve 5 is coated with an insulating mantle 23, itself protected by a protective casing 24 (which are also visible in FIG. 1).

The nozzle 10 is kept clamped between the plates 21 and 22 with the aid of screws 18, the tightening force of which is adjusted with the aid of springs 20. In this embodiment, the fastening means are positioned on a portion of the nozzle located outside of the regenerator.

In the embodiments from FIGS. 1, 2A and 2B, the fastening means are positioned on a portion of the nozzle located inside of the regenerator. They could however be located, as for the embodiment from FIG. 2C, on a portion located outside of the regenerator.

The invention may make it possible to design nozzles 10 with greater freedom of design as regards the shape in so far as it is less necessary than in the prior art to take into account the problem of erosion by the catalyst.

In particular, a shape could be provided that makes it possible to optimize the injection of fuel, which may make it possible to improve the combustion quality, and therefore to further preserve the catalyst, which may be beneficial for the environment.

In addition, the maintenance operations, capable of imposing shutdowns and of limiting catalytic cracking, may be carried out less frequently than in the prior art.

Finally, this type of injection system may prove more reliable than in the prior art and therefore may make it possible to limit the risk of unscheduled catalytic cracking shutdown.

1.-11. (canceled)

12. An injection element for an injection system for injecting fuel into a regenerator of a fluid catalytic cracking unit, the injection element comprising:
a flow passage and being arranged so as to be able to be firmly attached to an orifice passing through the regenerator so that one end of the flow passage is connected to a duct for supplying the injection system with fuel and the other end of this flow passage opens inside the regenerator,
characterized in that the injection element is made of ceramic material comprising a ceramic matrix and carbon and/or ceramic fibres incorporated into this ceramic matrix.

13. The injection element according to claim 12, in which the ceramic material comprises silicon carbide SiC, preferably in a majority amount.

14. The injection element according to claim 12, in which the ceramic material is a Ceramic Matrix Composite (CMC).

15. An injection system for injecting fuel into a regenerator of a fluid catalytic cracking unit, the system comprising at least one injection element according to claim 12, and at least one fuel supply duct, in which the at least one injection element is arranged so that one end of the fuel injection flow passage is connected to the duct.

16. The injection system according to claim 15, in which, for at least one injection element, the injection system comprises a support sleeve inside which the injection element extends, this support sleeve being intended to be positioned through a wall of the regenerator, the injection element being arranged so as to be firmly attached to this support sleeve.

17. The injection system according to claim 15, in which, for at least one injection element, the injection system comprises a device for fastening the injection element to the support sleeve, the fastening device being capable of absorbing a difference in expansion between the material of the support sleeve and the ceramic material of the injection element.

18. The injection system according to claim 15, in which, for at least one injection element, the fastening device comprises at least one pressing element capable of exerting a force on this injection element in order to press this injection element against the support sleeve.

19. The injection system according to claim 18, in which the pressing element comprises a tab welded via one end to the support sleeve and the other end of which is capable of exerting an elastic bearing force on the injection element when the injection element is installed inside the support sleeve.

20. The process for manufacturing a fuel injection element for a regenerator of a catalytic cracking unit, so that the fuel injection element defines a flow passage for the fuel, one end of which is intended to be connected to a fuel supply duct, and the other end of which is intended to open inside the regenerator, the process being characterized in that the injection element is made of ceramic material comprising a ceramic matrix and carbon and/or ceramic fibres incorporated into this ceramic matrix, the process comprising:
1) shaping a fibrous ceramic material eventually over a supporting material that could be removed without excessive effort, in order to obtain a fibrous shape that can be assimilated to the backbone of the final device to be obtained, in the presence of a first resin,
2) coating the shape obtained at step (1) with finely divided ceramic powder and at least a second resin, in the presence of finely divided carbon powder, to obtain a coated shape,
3) repeat steps (1) and (2),
4) heating the coated shape of step (2) or (3) under vacuum and/or under inert atmosphere in order to transform the resins of step (1), (2) and (3) into a carbon-rich structure, essentially deprived of other elements to obtain a carbon-rich coated shape,
5) introducing a gas within the carbon-rich coated shape of step (4) under conditions efficient to transform the carbon-rich structure into carbide containing carbon-rich structure,
6) removing the supporting material of step (1), when present,
wherein carbon fibers are present at least at step (1), (2) and/or (3) within the fibrous ceramic material, within the finely divided ceramic powder, within the finely divided carbon powder, and/or within the first and/or second resin.

21. The manufacturing process according to claim 20, comprising a step of sintering silicon carbide SiC particles.
